(19) United States
(12) Patent Application Publication
(10) Pub. No.: US 2025/0023377 A1
(43) Pub. Date: Jan. 16, 2025

(54) ENERGY-EFFICIENT ELECTRICAL POWER DISTRIBUTION IN MAINS-CONNECTED BATTERY MACHINE

(71) Applicant: EPIROC ROCK DRILLS AKTIEBOLAG, Örebro (SE)

(72) Inventor: Jörgen ALBREKTSSON, Örebro (SE)

(21) Appl. No.: 18/712,284

(22) PCT Filed: Sep. 22, 2022
(86) PCT No.: PCT/SE2022/050841

§ 371 Date: May 22, 2024

(30) Foreign Application Priority Data
Nov. 22, 2021 (SE) 2151418-7

(51) Int. Cl. H02J 7/04; H02J 7/00

(52) U.S. Cl. CPC H02J 7/04; H02J 7/0048; H02J 7/00714; H02J 7/007182; H02J 2207/20

(57) ABSTRACT

An electrical power distribution system is disclosed. A line converter is connectable to a mains power source and an on-board battery. An electronic control system is configured to control the line converter. A first sensor arrangement is configured to measure electric current into or out of the battery. A second sensor arrangement is configured to determine a current battery voltage. The electronic control system is arranged to receive a charge/discharge power request and control the line converter to regulate the line converter output voltage using a voltage reference obtained from a setpoint electric current into or out of the battery and the measured electric current into or out of the battery, where the setpoint electric current into or out of the battery is derived as a quota of the charge/discharge power request and the determined current battery voltage.

### FIELD OF THE INVENTION

The present invention relates to the field of electrical power distribution in an electrically powered mining or construction machine, and more specifically to an electrical power distribution system at an electrically powered mining or construction machine that includes a line converter connectable to a mains power source and a battery mounted on board the machine where both the mains power source and the battery are connected to a DC bus arranged to supply on board consumers of electrical energy and a method of electrical power distribution in such a system.

### BACKGROUND OF THE INVENTION

To provide mobility, it is common that devices today are equipped with a battery or battery pack, e.g. portable radios, lap-tops and electric cars. For some such devices, the battery is charged using an external charger at dedicated times, e.g. charging of electric cars. Other devices may have an on-board charger, e.g. some portable radios and laptops. When their power cord is connected to the mains their batteries are charged, which means that it is possible to have such appliances connected to the mains while they are being used, thus extending the usage time before their batteries runs out.

The strategy for how a battery is charged when a device is used at the same time is often of a so-called “bang-bang” nature, i.e. the battery is charged to a high State of Charge (SOC) level (e.g. maximum battery voltage) whereupon the charging is switched off and the battery voltage (SOC) drops. When the battery voltage has dropped to a predefined level, charging again starts at full capacity until the high charge level is reached once again. Sometimes a lower maximum charge level is defined than the battery's maximum capacity and the battery charge regulation then takes place in the same way but between lower charge levels, this to give the battery a longer life.

When using the above-described battery charging strategy, there is always power going either in or out of the battery, which results in substantial energy losses as energy losses will occur both when the battery is being charged and when it is being discharged. The above charging strategy also gives rise to a significantly reduced battery life due to the fact that the number of cycles when the battery is charged/discharged is high and that these cycles are quite powerful, i.e. large amounts of electrical current travels into or out of the battery.

Surface drill rigs, which are typically used in open pits, road construction and construction sites to drill holes in rock so that e.g. blasting can then be carried out, today is driven almost exclusively by internal combustion engines, typically diesel engines. The combustion engine converts liquid or gaseous chemical energy into kinetic energy that drives the surface drill rig. Internal combustion engines have a disadvantage in that the exhaust gases they emit contain gases that are harmful to the environment, e.g. NOx, HC, CO, PM but also CO2 which has a climate impact. By replacing the energy source with electricity and the motors with electric motors, it is possible to have almost zero exhaust emissions from such surface drill rigs. Energy efficiency also increases when internal combustion engines are replaced by electric motors as these have higher efficiency.

In order to be able to operate a surface drill rig with electricity, electrical energy must be supplied to the surface drill rig or alternatively stored on board. Traditionally, comparable machines, e.g. electric Pit-Vipers or electric underground drill rigs, are supplied with electricity from the electrical grid via a cable.

One difficulty, when supplying a surface drill rig with electrical energy via a cable, is that the cable makes it difficult to move the surface drill rig as the surface drill rig must always be connected to the electrical grid and the cable, for practical reasons, has a limited length limiting furthest travel. Furthermore, the cables used are often thick and rigid making them awkward to avoid when performing complex maneuvering with the surface drill rig or when repeatedly reversing shorter distances whilst adjusting the position thereof. It is generally difficult to move the surface drill rig and avoid running over the cable, which can be severely damaged or severed by running over it.

To reduce the difficulty of cable management and to increase the autonomy of the electric surface drill rig, the surface drill rig can be equipped with an electrical energy storage, e.g. an electric battery. In this way, the surface drill rig can be used without a cable connected.

One problem with having only one energy storage on board the surface drill rig is that the energy storage is finite, i.e. a battery must be charged. When the battery is charged, the actual work of the surface drill rig, i.e. drilling holes, must be paused and working hours are lost. Depending on the size of the battery supplied the surface drill rig, this may happen often.

Another problem is that degradation of the battery may further increase charging requirements, i.e. shorten the required charging intervals, thus further increase the loss in working hours. Also, degradation of the battery will eventually result in costly exchange of the battery.

### SUMMARY OF THE INVENTION

An objective of the present disclosure is to provide a simple and secure solution for energy efficient electrical power distribution at an electrically powered mining or construction machine.

This is provided by an electrical power distribution system at an electrically powered mining or construction machine that includes a line converter connectable to a mains power source and a battery mounted on board the machine where both the mains power source and the battery are connected to a DC bus arranged to supply on board consumers of electrical energy, the system comprising: an electronic control system configured to control the line converter; a first sensor arrangement configured to measure electric current into or out of the battery; a second sensor arrangement configured to determine a current battery voltage; wherein the electronic control system is arranged to receive a charge/discharge power request and control the line converter to regulate the line converter output voltage using a voltage reference obtained from a setpoint electric current into or out of the battery and the measured electric current into or out of the battery, where the setpoint electric current into or out of the battery is derived as a quota of the charge/discharge power request and the determined current battery voltage.

The herein proposed system ensures an energy and cost-effective electrical power distribution system implementing a control strategy that minimizes the electric current brought into and drawn from the battery during varying operating conditions rendering the machine more energy efficient and providing for an increased battery life.

In one embodiment, the system is further arranged to generate the charge/discharge power request based on a target battery state-of-charge and a current battery state-of-charge.

In one embodiment, the system further comprises a man-machine-interface for selectively setting at least one of a charge/discharge power limit and the target battery state-of-charge, and the system is further arranged to generate the charge/discharge power request based on the at least one of the set charge/discharge power limit and the set target battery state-of-charge.

In one embodiment, the system further comprises a machine control system interface for receiving at least one of the charge/discharge power request and the target battery state-of-charge from a machine control system.

In one embodiment, the electronic control system is arranged to obtain the voltage reference from the setpoint electric current into or out of the battery and the measured electric current into or out of the battery using a first regulator.

In one embodiment, the electronic control system is further arranged to generate the charge/discharge power request from the target battery state-of-charge and the current battery state-of-charge using a second regulator.

In a second aspect of the present disclosure, there is provided a method of electrical power distribution in a system as described herein, the method comprising: measuring an electric current into or out of the battery; determining a current battery voltage; receiving a charge/discharge power request; obtaining a setpoint electric current into or out of the battery as a quota of the charge/discharge power request and the determined current battery voltage; controlling the line converter to regulate the line converter output voltage using a voltage reference obtained from the setpoint electric current into or out of the battery and the measured electric current into or out of the battery.

In one embodiment, the method further comprises generating the charge/discharge power request based on a target battery state-of-charge and a current battery state-of-charge.

In one embodiment, the method further comprises receiving at least one of a charge/discharge power limit and the target battery state-of-charge from a man-machine-interface, and generating the charge/discharge power request based on the at least one of the set charge/discharge power limit and the set target battery state-of-charge.

In one embodiment, the method further comprises receiving at least one of the charge/discharge power request and the target battery state-of-charge from a machine control system.

In a third aspect of the present disclosure, there is provided a non-transitory computer-readable storage medium that stores a program configured to execute the method of electrical power distribution in an electrical power distribution system according to the second aspect.

In a fourth aspect of the present disclosure, there is provided a computer program product comprising instructions which, when the program is executed by a computer, cause the computer to carry out the method of electrical power distribution in an electrical power distribution system according to the second aspect.

### BRIEF DESCRIPTION OF THE DRAWINGS

With reference to the appended drawings, below follows a more detailed description of example embodiments of the invention, wherein:

FIG. 1 shows a schematic view of a surface drill rig that is electrified and has an electric battery on-board and the possibility of connecting a cable to the electrical grid;

FIG. 2 shows a simplified block diagram of an example electrical system in a surface drill rig as shown in FIG. 1;

FIG. 3 illustrates schematically a control strategy for energy-efficient electrical power distribution in a mains-connected battery machine;

FIG. 4 illustrates schematically two control loops for implementing the control strategy illustrated in FIG. 3.

### DETAILED DESCRIPTION OF EXAMPLE EMBODIMENTS

In the following, a detailed description of an electrical power distribution system 1 at an electrically powered mining or construction machine 2 according to the present disclosure is presented.

The electrically powered mining or construction machine 2 includes a line converter 5 connectable to a mains power source 4 and a battery 6 mounted on-board the machine 2 where both the mains power source 4 and the battery 6 are connected to a DC bus 7 arranged to supply on-board consumers 8 of electrical energy. Batteries 6, as described herein, also include supercapacitors or other types of chargeable/dischargeable electric energy storages.

In the drawing figures, like reference numerals designate identical or corresponding elements throughout the several figures. It will be appreciated that these figures are for illustration only and do not in any way restrict the scope of the present disclosure.

The expression “mining or construction machines” as used in the present disclosure may include production, exploration, and construction mining rigs.

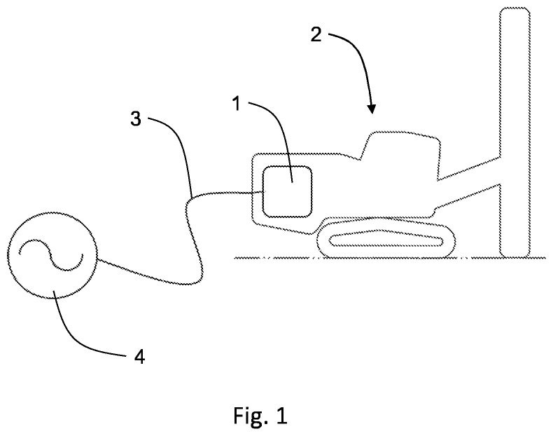

With reference to FIG. 1, is illustrated schematically a surface drill 2 rig used to exemplify the invention, which surface drill rig 2 is electrified and has an electric battery 6 on-board and the possibility of connecting, via a line converter 5, a cable 3 to an electrical grid 4.

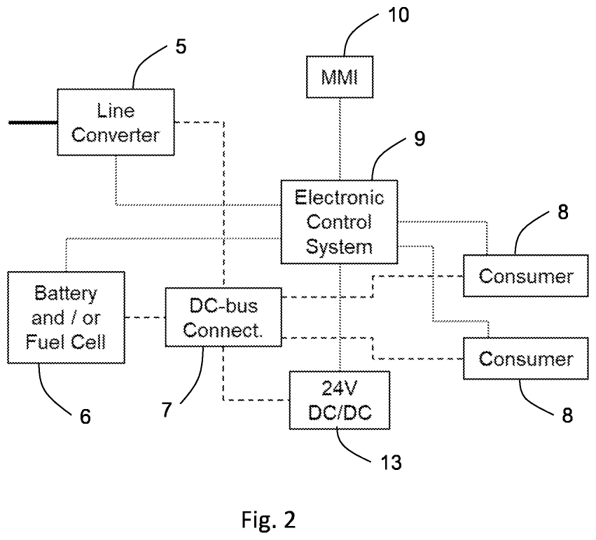

With reference to FIG. 2, there is shown a simplified block diagram of an example electrical system 1 of such a machine 2 as described herein. A Man Machine Interface (MMI) 10 is provided for enabling a machine operator to interact with an electronic control system (ECS) 9 of the machine 2. A line converter 5 is selectively connectable to a mains power source 4, e.g. electrical grid, as well as to a battery 6 and/or fuel cell mounted on-board the machine 2.

Both the mains power source 4 and the battery 6 and/or fuel cell are connected to a DC bus 7 arranged to supply on-board consumers 8 of electrical energy. These on-board-consumers 8 may be inverters which in turn supplies electric motors. A low voltage system 13, here illustrated as 24V DC/DC, is provided for powering the electronic control system 9.

In FIG. 2, electric grid power lines are drawn as full lines, electric DC power lines are dashed, and control signal lines are shown as dotted. The block diagram of FIG. 2 has been simplified through the omission of some components that may be required depending on the particular implementation, such as transformers, filters, inverters for powering some on-board consumers, battery/fuel cell control and thermal management systems etc., as will be evident to the skilled person.

For the configuration shown in FIG. 2 it is possible to, at a high level, define a number of energy supply modes (ESM). These may be:
ESM Automatic mode, which is used when both the battery 6 and the cable 3 for the electrical network 4 are connected. In ESM Automatic mode, the power taken out of the electrical network 4 and transmitted to the DC bus 7 is controlled by the electronic control system 9, which in turn controls the Line converter 5. By controlling the power from the electrical network 4 as described in the following, it will be possible to either only use energy from the electrical network 4 to supply the consumers 8 (motors, DC/DC converters, etc.) with energy, and the current SOC level of the battery 6 will not change, or, alternatively, it will be possible to control more power from the grid 4 via the electronic control system 9/Line converter 5 than the consumers 8 dispose of, the battery 6 will then be charged (SOC increases), or it will be possible to control, via the electronic control system 9/Line converter 5, less power from the grid 4 than what the consumers 8 do away with, and the battery 6 will then be discharged and the battery 6 used as an energy source (SOC decreases). In this ESM Automatic mode, a surface drill rig 2 will have the opportunity to perform all the work steps that it normally performs.
ESM Battery mode, in which a cable 3 to the electrical network 4 is not connected, but the surface drill rig's 2 energy supply takes place completely from the battery 6. In this ESM Battery mode, a surface drill 2 rig has the opportunity to perform all the work steps that it normally performs as long as there is energy left in the battery 6.
ESM Electric Grid mode, in which the battery 6 is not connected to the surface drill rig ‘s 2 electrical system, but the surface drill rig's 2 energy supply takes place entirely from the electrical network 4. In this ESM Electric Grid mode, the surface drill rig 2 has the ability to perform all the normal operations that it usually performs but must remain connected to the electrical network 4.
ESM Auxiliary power mode, which is used to supply the surface drill rig 2 with energy when not in use. In ESM Auxiliary power mode, the surface drill rig 2 can either only be connected to the electrical network 4, only have the battery 6 connected or have both battery 6 and electrical network 4 connected. ESM Auxiliary power mode can e.g. be used to supply the surface drill rig 2 with energy from the mains 4 so that the battery 6 is charged when the surface drill rig 2 is not in use or supply the surface drill rig 2 with energy from a battery 6 or mains 4 so that e.g. selected components and/or an operator cab can be heated when the surface drill rig 2 is not in use. In ESM Auxiliary power mode, the functions for performing the surface drill rig's 2 normal operation are locked, e.g. via a key, so that the surface drill rig 2 does not move involuntarily.

The proposed control strategy is only applicable in Energy Supply Modes where both a mains power source 4 and a battery 6 are connected to the DC bus 7, i.e. in modes such as the ESM Automatic mode and ESM Auxiliary power mode described above.

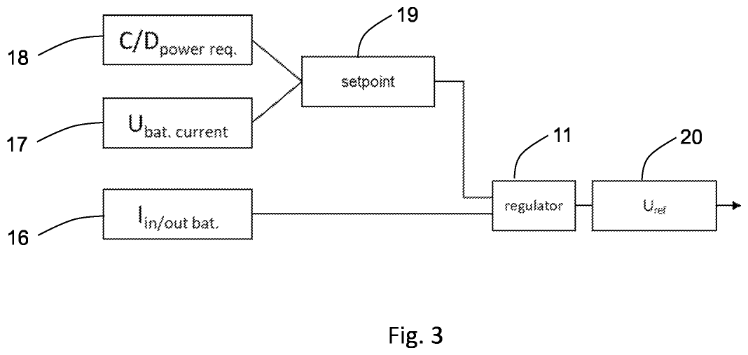

Thus, the electrical power distribution system 1 comprises the electronic control system 9, which is configured to control the line converter 5. As illustrated in FIG. 3 first sensor arrangement 16 is configured to measure electric current I_{in/out bat.} into or out of the battery 6, and a second sensor arrangement 17 is configured to determine a current battery 6 voltage U_{bat. current}.

The electronic control system 9 is further arranged to receive at box 18 a charge/discharge power request C/D_{power req.} and control the line converter 5 to regulate the line converter 5 output voltage U_{ref} at box 20 using a voltage reference obtained from a setpoint 19 electric current into or out of the battery 6 and the measured electric current I_{in/out bat.} into or out of the battery 6. The setpoint 19 electric current into or out of the battery 6 is derived as a quota of the charge/discharge power request C/D_{power req} and the determined current battery 6 voltage U_{bat. current}.

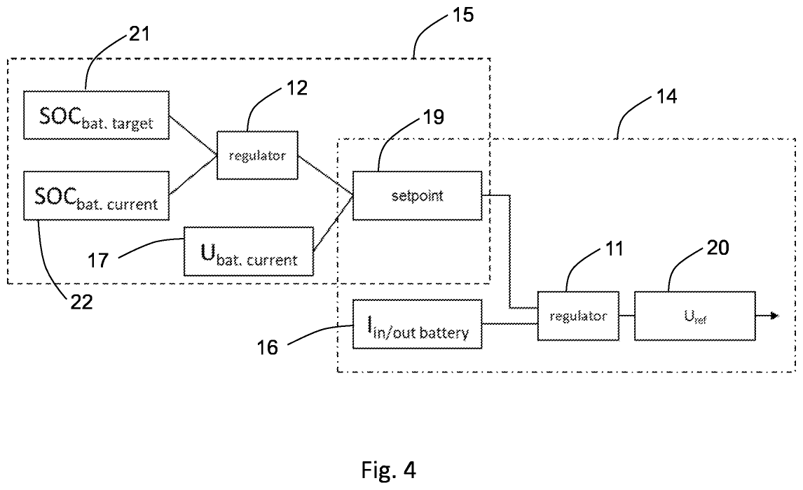

In some embodiments, as illustrated in FIG. 4, the electronic control system 9 is arranged to generate the charge/discharge power request C/D_{power req} based on a target battery 6 state-of-charge SOC_{bat. target} at box 21 and a current battery 6 state-of-charge SOC_{bat. current} at box 22.

The electrical power distribution system 1 suitably comprises a man-machine-interface 10 for selectively setting at least one of a charge/discharge power limit and the target battery 6 state-of-charge SOC_{bat. target}, and the system 1 is further arranged to generate the charge/discharge power request C/D_{power req.} based on the at least one of the set charge/discharge power limit and the set target battery 6 state-of-charge SOC_{bat. target}.

The electrical power distribution system 1 according to some embodiments comprises a machine control system interface (not shown) for receiving at least one of the charge/discharge power request C/D_{power req.} and the target battery 6 state-of-charge SOC_{bat. target} from a machine control system (not shown).

The electronic control system 9 may, in some embodiments, be arranged to obtain the voltage reference from the setpoint electric current into or out of the battery 6 and the measured electric current I_{in/out battery} into or out of the battery 6 using a first regulator 11. The regulator may be of P, PI or PID type or other types of commonly used regulators.

The electronic control system 9 is further arranged to generate the charge/discharge power request C/D_{power req.} from the target battery 6 state-of-charge SOC_{bat. target} and the current battery 6 state-of-charge SOC_{bat. current} using a second regulator 12. The second regulator may also be of P, PI or PID type or other types of commonly used regulators.

FIG. 3 illustrates schematically a control strategy for energy-efficient electrical power distribution in a machine 2 that has a mains power source 4 and a battery 6 connected to a DC bus 7 as described herein.

By regulating the voltage on the mains power source 4, it is possible to control the current I_{in/out bat.} that goes in or out of the battery 6. This enables three possible strategies in terms of energy supply to the machine 2 and the battery's 6 SOC level:
i) By setting the setpoint 19 of the controller 11 to zero, the controller 11 will regulate the voltage of the mains power source 4 so that it is approximately equal to the voltage of the battery 6. The mains power source 4 will then emit just as much power as the on-board consumers 8 dispose of without any power going to or from the battery 6. The current SOC level of the battery 6 will not change.
ii) By setting the setpoint 19 of the controller 11 to a value greater than zero, the controller 11 will regulate the voltage of the mains power source 4 so that it is higher than the voltage of the battery 6. The mains power source 4 will then emit more power than the consumers 8 dispose of and the battery 6 will be charged (SOC increases). A controlled electric current, approximately equal to the setpoint 19, will enter the battery 6.
iii) By setting the setpoint 19 of the controller 11 to a value less than zero, the controller 11 will regulate the voltage of the mains power source 4 so that it is lower than the voltage of the battery 6. The mains power source 4 will then emit less power than the consumers 8 dispose of and the battery 6 will be discharged in a controlled manner, i.e. the battery 6 will be used as an energy source (SOC decreases). A controlled electric current, about equal to the setpoint 19, will go out of the battery 6.

In cases where the mains power source's 4 power is limited to a lower level than the on-board consumers 8 can consume, a high-power output (e.g. a transient load on an electric motor) that is greater than the mains power source's 4 current power limit will result in the voltage on the DC bus 7 falling. When the battery 6 voltage remains at a higher level, current will flow out of the battery 6, which compensates for the power that is missing in the system 1. In this way, it becomes possible to handle temporary power peaks in the system 1 that the mains power source 4 cannot handle due to its power limitation, this is sometimes also referred to as “peak shaving”.

The proposed control strategy enables having a battery 6 connected as an energy source in parallel with a mains power source 4 (e.g. an electrical network and a line converter, an internal combustion engine driven generator or a fuel cell) and then choose which energy source the energy to be consumed is taken from. It also enables controlling charging and discharging of the battery 6 in an efficient and precise way.

Thus, in order to implement the proposed control strategy, envisaged herein is also a method of electrical power distribution in a system 1 as described herein. The method comprises measuring an electric current I_{in/out bat.} into or out of the battery 6 and determining a current battery 6 voltage U_{bat. current}. A charge/discharge power request C/D_{power req.} is received and a setpoint 19 electric current into or out of the battery obtained as a quota of the charge/discharge power request C/D_{power req.} and the determined current battery 6 voltage U_{bat. current}. The line converter 5 is controlled to regulate the line converter 5 output voltage using a voltage reference obtained from the setpoint 19 electric current into or out of the battery 6 and the measured electric current I_{in/out bat.} into or out of the battery 6.

The charge/discharge power request may C/D_{power req.}, as illustrated in FIG. 4, be generated based on a target battery 6 state-of-charge and a current battery 6 state-of-charge.

The method may further comprise receiving at least one of a charge/discharge power limit and the target battery 6 state-of-charge SOC_{bat. target} from a man-machine-interface 10, and generating the charge/discharge power request C/D_{power req.} based on the at least one of the set charge/discharge power limit and the set target battery 6 state-of-charge SOC_{bat. target}.

The method may still further comprise receiving at least one of the charge/discharge power request C/D_{power req.} and the target battery 6 state-of-charge SOC_{bat. target} from a machine control system.

FIG. 4 illustrates schematically two control loops 14, 15 for implementing the above-described control strategy. A first control loop 14, essentially corresponding to that of FIG. 3 is shown within a dash-dotted line frame, and a second control loop 15 shown within a dashed line frame, which second control loop 15 is provided for generating the charge/discharge power request C/D_{power req.} based on the target battery 6 state-of-charge SOC_{bat. target} and a current battery 6 state-of-charge SOC_{bat. current}.

The input signal to the first control loop 14 of FIG. 4 is the “setpoint” desired current in or out of the battery 6. By varying the desired current in or out of the battery 6, the SOC level of the battery 6 is controlled. In this embodiment, it is conceivable that a surface drill rig 2 operator or a service personnel selects a desired SOC level SOC_{bat. target} in the machine's 2 MMI 10 that a second control loop 15 tries to maintain.

Alternatively, a fixed desired SOC level can be set as a parameter in a machine control system. The second control loop 15 regulates the desired current in/out of the battery (setpoint 19 to the first control loop 14) based on a control error in SOC level, see FIG. 4. In the second control loop 15, the desired SOC level SOC_{bat. target} is setpoint and the current SOC level SOC_{bat. current} reported by the battery 6 is actual value. The second control loop 15 controls a desired charging power which is converted into current by the formula:

$$I = P / U \qquad ( 1 )$$

where I=electrical current, P=electrical power and U=electrical voltage. Calculated charging current is sent as setpoint 19 to the first control loop 14. In this way, the function will always strive to maintain the desired SOC level.

In order not to overload the mains power source 4, it will be necessary to limit the electrical power to the DC bus 7 from the mains power source 4. In the case of a machine 2 comprising a mains-connected cable 3, possibly with an associated cable reel (not shown), and a line converter 5 with an associated transformer and filter, this limitation is calculated as:

$${P}_{max , LC} = min ( {P}_{max , mains} , {P}_{max , cable reel} , {P}_{max , transf} ( T ) , {P}_{max , filter} ( T ) , {P}_{max , lineconv} ) \qquad ( 2 )$$

where: P_{max, mains}=Maximum power that the mains 4 can be loaded with, P_{max, cable reel}=Maximum power for a possible cable reel, P_{max, transf}(T)=Temperature-dependent maximum power for a transformer, P_{max, Filter}(T)=Temperature-dependent maximum power for any filters, P_{max, lineconv}=Line converter 5 maximum power.

In a case where an internal combustion engine and a generator is used, a fixed parameter is set for the system's maximum power to the DC bus 7, or the maximum power is read out from the engine's control system via a Controller Area Network (CAN). In the case of a fuel cell, the maximum power is read out via the CAN.

When the maximum power of the mains power source 4 is determined, the power consumed is limited by limiting the maximum power of the consumers 8 in a predetermined order of priority. In a first step, the power that charges the battery 6 is limited, in a next step, the cab's heating and cooling system is shut down, then the power that any motors of the machine 2 can draw is limited.

Some advantages of the proposed control strategy are that by controlling the electrical consumption to only come from the mains power source 4, the energy losses that occur when energy goes in and out of the battery 6 are avoided and that the battery 6 life is extended. Extension of battery 6 life is achieved as there will be fewer and lower amplitudes on charge/discharge cycles.

Envisaged herein is also a non-transitory computer-readable storage medium that stores a program configured to execute the herein described method in an electrical power distribution system 1 as described herein.

The non-transitory computer-readable storage medium, that stores a program configured to execute the method of electrical power distribution at an electrically powered mining or construction machine 2, is suitably a non-volatile memory, i.e. a memory that retains stored data after power is turned off, such as an electrically erasable programmable read-only memory (EEPROM), a flash Read-only Memory (ROM), a hard disk drive (HDD), solid state drive (SSD), an optical storage media or similar.

Envisaged herein is also a computer program product comprising instructions which, when the program is executed by a computer, cause the computer to carry out the herein described method in an electrical power distribution system 1 as described herein.

Although the invention has been illustrated and described in detail in the drawings and foregoing description, such illustration and description are to be considered illustrative or exemplary and the invention is not limited to the disclosed embodiments. For example, the non-transitory computer-readable storage medium may, where an electronic control system 9 is connected, i.e. has a wired or wireless connection to a computer network, such as the internet, alternatively be located remote from the electronic control system 9, e.g. in a remote server or so-called cloud-service, and accessed via a wired or wireless connection.

1. An electrical power distribution system at an electrically powered mining or construction machine that includes a line converter connectable to a mains power source and a battery mounted on board the machine where both the mains power source and the battery are connected to a DC bus arranged to supply on board consumers of electrical energy, the system comprising:
an electronic control system configured to control the line converter;
a first sensor arrangement configured to measure electric current into or out of the battery;
a second sensor arrangement configured to determine a current battery voltage;
wherein
the electronic control system is arranged to receive a charge/discharge power request and control the line converter to regulate the line converter output voltage using a voltage reference obtained from a setpoint electric current into or out of the battery and the measured electric current into or out of the battery, where the setpoint electric current into or out of the battery is derived as a quota of the charge/discharge power request and the determined current battery voltage.

2. The system according to claim 1, wherein the electronic control system is further arranged to generate the charge/discharge power request based on a target battery state-of-charge and a current battery state-of-charge.

3. The system according to claim 1, wherein the system further comprises a man-machine-interface for selectively setting at least one of a charge/discharge power limit and the target battery state-of-charge, and the system is further arranged to generate the charge/discharge power request based on the at least one of the set charge/discharge power limit and the set target battery state-of-charge.

4. The system according to claim 1, wherein the system further comprises a machine control system interface for receiving at least one of the charge/discharge power request and the target battery state-of-charge from a machine control system.

5. The system according to claim 1, wherein the electronic control system is arranged to obtain the voltage reference from the setpoint electric current into or out of the battery and the measured electric current into or out of the battery using a first regulator.

6. The system according to claim 2, wherein the electronic control system is further arranged to generate the charge/discharge power request from the target battery state-of-charge and the current battery state-of-charge using a second regulator.

7. A method of electrical power distribution in a system, the method comprising:
measuring an electric current into or out of the battery;
determining a current battery voltage;
receiving a charge/discharge power request;
obtaining a setpoint electric current into or out of the battery as a quota of the charge/discharge power request and the determined current battery voltage; and
controlling the line converter to regulate the line converter output voltage using a voltage reference obtained from the setpoint electric current into or out of the battery and the measured electric current into or out of the battery.

8. The method according to claim 7, further comprising generating the charge/discharge power request based on a target battery state-of-charge and a current battery state-of-charge.

9. The method according to claim 7, further comprising receiving at least one of a charge/discharge power limit and the target battery state-of-charge from a man-machine-interface, and generating the charge/discharge power request based on the at least one of the set charge/discharge power limit and the set target battery state-of-charge.

10. The method according to claim 7, further comprising receiving at least one of the charge/discharge power request and the target battery state-of-charge from a machine control system.

11. A non-transitory computer-readable storage medium that stores a program, which when executed on at least one processor, causes the at least one processor to:
measure an electric current into or out of a battery;
determine a current battery voltage;
receive a charge/discharge power request;
obtain a setpoint electric current into or out of the battery as a quota of the charge/discharge power request and the determined current battery voltage;
control a line converter to regulate the line converter output voltage using a voltage reference obtained from the setpoint electric current into or out of the battery and the measured electric current into or out of the battery.

12. (canceled)
